(19) United States
(12) Patent Application Publication
(10) Pub. No.: US 2010/0097639 A1
(43) Pub. Date: Apr. 22, 2010

(54) Space Context Copy/Paste Method and System, and Space Copier

(76) Inventors: Nam Yeon Lee, Gunpo-City (KR); Yoon Hyoung Choi, Wonju-City (KR); O Byung Kwon, Yongin-City (KR); Tae Hwan Park, Yongin-City (KR); Jae Moon Sim, Daegu-City (KR)

Correspondence Address: MAXON IP LLC, 46175 WESTLAKE DR., SUITE 410, POTOMAC FALLS, VA, 20165, US

(21) Appl. No.: 12/516,197

(22) PCT Filed: Nov. 12, 2007
(86) PCT No.: PCT/KR2007/005662

§ 371 Date: Dec. 23, 2009

(30) Foreign Application Priority Data
Nov. 24, 2006 (KR) 10-2006-0116832
Nov. 24, 2006 (KR) 10-2006-0116835
Nov. 24, 2006 (KR) 10-2006-0116839

(51) Int. Cl. G06F 3/12

(52) U.S. Cl. 358/1.15

(57) ABSTRACT

A space context copy/paste method and system using ontology, and a space copier are disclosed, in which various contexts in a space are sensed using various detection means under a ubiquitous environment and are stored in a database by time, and a context of a specific space to be copied or pasted by a user is stored in a space file using a space copier, so that a user is able to paste the stored space file into a specific space using various output means.

### TECHNICAL FIELD

The present invention relates to a space context copy/paste method and system using ontology, and a space copier, and in particular to a space context copy/paste method and system using ontology, and a space copier in which various contexts in a space are sensed using various detection means under a ubiquitous environment and are stored in a database by time, and a context of a specific space to be copied or pasted by a user is stored in a space file using a space copier, so that a user is able to paste the stored space file into a specific space using various output means.

### BACKGROUND ART

In recent years, as an information industry and a mobile communication technology are advanced, the use of a computer sharply increases while changing the general concept even as a personal computer. Namely, a ubiquitous computing system is developed for providing an easier computing environment to users by connecting all service terminals equipped with computers through a network in a new paradigm. The above computing environment represents a new network environment which needs an integral management and interconnected operation, not for a simple control of a fixed or movable node.

Therefore, in the ubiquitous computing environment, a certain new technology is needed, which is able to allow the contents of services to adaptively change depending on a context including a service specification information of a service terminal as well as the current position and activity of a user.

Here, the context represents information related with a certain situation of an entity such as a person, place or thing. In the ubiquitous computing environment, various context awareness applications are possible to actively provide a certain service adaptable to a given situation using a context related with the entities. The system needs context awareness with respect to a surrounding situation of a user so that a wide range of services can be provided to the users under the ubiquitous environment. The research of a ubiquitous sensor network for well recognizing the current surrounding situation is focused on an infrastructure for operating a protocol of a sensor network and a sensor network. Here, a communication between sensors and an interoperation between the systems for integrating the same are important issues for the construction of an infrastructure. However, a result of the researches is poor for substantially describing a physical environment needed for actually operating the systems.

A certain modeling with respect to a context is needed in order for the system to recognize the surrounding situation. However, almost the above researches are focused on a process of the contexts and fail to disclose a detailed method needed for the modeling of the context. In addition, it is impossible to find an actually modeled context. In the examples of the modeled contexts which may be rarely found, only the contexts of small units used for the certification of the system suggested in a corresponding research are included, so that a detailed method for expressing the contexts is not disclosed.

In the conventional ubiquitous environment, the context collection system for a context-awareness application uses only the position recognition sensor for recognizing the position of the entity. Even when another kind of the sensor is used, the context related with a corresponding entity is collected using a sensor belonging to a specific entity. A method for collecting the contexts of various entities using one sensor is not disclosed.

The speed recognition sensor is able to recognize the speed of a certain entity as well as all the speeds of entities which pass through in front of the same, but the speed recognition sensor is not able to provide information in a state that the speed corresponds to which entity, so that its application is very limited. Namely, the scope of sensors used for context awareness is limited, and the diversities of contexts are not fully applicable.

### DISCLOSURE OF INVENTION

### Technical Problem

Accordingly, it is an object of the present invention to provide a space context copy/paste method and system using ontology, and a space copier which overcomes the problems encountered in the conventional art.

It is another object of the present invention to provide a space context copy/paste method and system using ontology, and a space copier in which various contexts in a space are sensed using various detection means under a ubiquitous environment and are stored in a database by time, and a context of a specific space that a user wants to copy and paste is stored in a space file using a space copier, so that a user is able to paste the stored space file into a specific space using various output means.

### Technical Solution

To achieve the above objects, in a context copy method of a space using a detection means, a storing means, an output means and a space copier under a ubiquitous environment, there is provided a context copy/paste method of a space using ontology which comprises a step (a) in which when a copy signal of a space copier positioned in a specific space to be copied is inputted, a position information of the space copier is recognized, and transmitted to the storing means; a step (b) in which the storing means, which received the position information of the space copier, receives a context through the detection means positioned in the specific space to be copied and stores the context as a space file; a step (c) in which when a paste signal of the space copier positioned in the specific space to be pasted is inputted, the position information of the space copier is recognized, and transmitted to the storing means; and a step (d) in which the storing means, which received the position information of the space copier, searches and extracts the space file formed of the context of the specific space and an output means positioned in the space to be pasted, and outputs the context of the previously stored specific space to the outside through the extracted output means.

To achieve the above objects, in a system which includes a detection means for detecting at least one context under a ubiquitous environment, a storing means, a space copier and an output means, there is provided a context copy/paste system of a space using ontology which includes a plurality of detection means which have inherent identification numbers and store database by providing the URI of the context ontology, which is an inherent identifier, after sensing the context of the time-based specific space, and request the context of a corresponding space stored in the database is searched and transmitted to the storing means depending on the request of the storing means; a storing means which stores an inherent identification number, a user-based ID and password, and registers the inherent identification numbers and position information of the detection means, output means and space copier, and stores the same in a database, and provides the information of the detection means depending on the position of the space copier, and requests a copy of the context of a corresponding space to the detection means of the specific space using a copy condition of the specific space or the selected detection means received from the space copier, and stores into a database by the inherent identification numbers received from the space copier for thereby creating a space file, and searches and extracts a space file of the specific space coped and stored in the database using the inherent identification number received depending on a context paste request in the specific space from the space copier, and controls the output means of a corresponding specific space using the output condition received from the space copier; a space copier which has an inherent identification number, and senses an inherent identification number of the nearest detection means, and transmits to the storing means, and receives the information of the detection means which senses a context of a corresponding specific space to be copied or pasted, and transmits a copy or paste condition, a selected detection means and inherent identification number to the storing means, and requests a copy or paste of the context of a corresponding specific space; and a plurality of output means which output the context of a specific space to be pasted depending on the context when copying a corresponding specific space to the outside in accordance with a control of the storing means.

To achieve the above objects, in a context copy/paste system which uses a detection means for detecting at least one context under a ubiquitous environment, a storing means and an output means, there is provided a space copier using a context copy/paste method using ontology which comprises a space copier which has an inherent identification number, and requests a space file by the inherent identification numbers by copying a context of a specific space sensed from the detection means to be created and stored in the storing means, and requests an output the space file stored in the storing means by the inherent identification numbers through the output means.

### ADVANTAGEOUS EFFECTS

In a space context copy/paste method and system using ontology, and a space copier according to the present invention, a context needed for recognizing a surrounding environment in a ubiquitous environment is stored in a database through various detection means, and the contexts of various spaces can be copied and pasted using a portable space copier. The present invention may be efficiently used in an electronic commerce, a weather information provision service, a position information service provision, a financial transaction and the same space implementation provision.

As another effect of the present invention, a localization problem owing to a time and space may be overcome, and it is possible to provide a context depending on a personal subjectivity.

A context needed for recognizing a surrounding environment in a ubiquitous environment is combined or shared through a space copier, so that a user can produce a certain space of an atmosphere without visiting a specific space.

As further another effect of the present invention, at least two users positioned in different spaces combine or share at least one space, so that they feel like they do something in the same space in such a manner that one shop is copied and pasted in one space without moving to the same space.

### BRIEF DESCRIPTION OF THE DRAWINGS

FIG. 1 is a schematic view illustrating a system for a context copy and paste method using ontology according to an embodiment of the present invention;

FIG. 2 is a view illustrating a detailed block of a context copy and paste system using ontology according to an embodiment of the present invention;

FIG. 3 is a flow chart of a context copy and paste method using ontology according to an embodiment of the present invention;

FIG. 4 is a detailed flow chart of a context copy method using ontology according to an embodiment of the present invention;

FIG. 5 is a detailed flow chart of a context paste method using ontology according to an embodiment of the present invention;

FIG. 6 is a view illustrating a state that a context using ontology is copied and pasted in an augmented reality according to an embodiment of the present invention;

FIG. 7 is a view illustrating a process that a context using ontology is copied using a space copier according to an embodiment of the present invention;

FIG. 8 is a view illustrating a list of a space file copied for pasting a context using ontology according to an embodiment of the present invention;

FIG. 9 is a view illustrating a context of a space file selected among the copied space files for pasting a context using ontology according to an embodiment of the present invention;

FIG. 10 is a view illustrating an example of an output means which outputs a context to the outside after pasting a context using ontology to the output means according to an embodiment of the present invention;

FIG. 11 is a flow chart of a method for combining contexts using ontology according to an embodiment of the present invention; and

FIG. 12 is a flow chart of a method for sharing contexts using ontology according to the present invention.

### BEST MODE FOR CARRYING OUT THE INVENTION

In the present invention, in a context copy method of a space using a detection means, a storing means, an output means and a space copier under a ubiquitous environment, there is provided a context copy/paste method of a space using ontology which comprises a step (a) in which when a copy signal of a space copier positioned in a specific space to be copied is inputted, a position information of the space copier is recognized, and transmitted to the storing means; a step (b) in which the storing means, which received the position information of the space copier, receives a context through the detection means positioned in the specific space to be copied, and stores the context as a space file; a step (c) in which when a paste signal of the space copier positioned in the specific space to be pasted is inputted, the position information of the space copier is recognized, and transmitted to the storing means; and a step (d) in which the storing means, which received the position information of the space copier, searches and extracts the space file formed of the context of the specific space and an output means positioned in the space to be pasted, and outputs the context of the previously stored specific space to the outside through the extracted output means.

In a system which includes a detection means for detecting at least one context under a ubiquitous environment, a storing means, a space copier and an output means, there is provided a context copy/paste system of a space using ontology which includes a plurality of detection means which have inherent identification numbers and store database by providing the URI of the context ontology, which is an inherent identifier, after sensing the context of the time-based specific space, and request the context of a corresponding space stored in the database is searched and transmitted to the storing means depending on the request of the storing means; a storing means which stores an inherent identification number, a user-based ID and password, and registers the inherent identification numbers and position information of the detection means, output means and space copier, and stores the same in a database, and provides the information of the detection means depending on the position of the space copier, and requests a copy of the context of a corresponding space to the detection means of the specific space using a copy condition of the specific space received from the space copier or the selected detection means, and stores into a database by the inherent identification numbers received from the space copier for thereby creating a space file, and searches and extracts a space file of the specific space coped and stored in the database using the inherent identification number received depending on a context paste request in the specific space from the space copier, and controls the output means of a corresponding specific space using the output condition received from the space copier; a space copier which has an inherent identification number, and senses an inherent identification number of the nearest detection means, and transmits to the storing means, and receives the information of the detection means which senses a context of a corresponding specific space to be copied or pasted, and transmits a copy or paste condition, a selected detection means and inherent identification number to the storing means, and requests a copy or paste of the context of a corresponding specific space; and a plurality of output means which output the context of a specific space to be pasted depending on the context when copying a corresponding specific space to the outside in accordance with a control of the storing means.

In a context copy/paste system which uses a detection means for detecting at least one context under a ubiquitous environment, a storing means and an output means, there is provided a space copier using a context copy/paste method using ontology which comprises a space copier which has an inherent identification number, and requests a space file by the inherent identification numbers by copying a context of a specific space sensed from the detection means to be created and stored in the storing means, and requests an output the space file stored in the storing means by the inherent identification numbers through the output means.

### MODE FOR THE INVENTION

The space context copy/paste method and system using ontology, and a space copier according to the present invention will be described with reference to the accompanying drawings.

The term of context used in the present invention includes at least one physical information such as an object, luminance, temperature, sound, smell, shape or something in a space that a user wants, as well as at least one psychological information such as psychological anxiety, impatience, happiness, angry or something.

Here, the ontology is a formal and explicit specification with respect to a shared conceptualization. It may be called as a kind of dictionary formed of words and relations. Words related to a specific domain may be hierarchically expressed in the same. An inference rule for expanding is also included in the same. A web-based knowledge process or a knowledge sharing and reuse in an application program are also available.

The URN (Uniform Resource Name) is one of a system for recognizing an internet content and is an identification code for expressing various objects of internet resources for expressing names and positions of document, image, file, database, e-mail or something for thereby providing uniformity, continuousness, expansion, circulation and dimension by providing each content with names irrespective of the position of contents, protocol, host or something.

In the present invention, the URI of context ontology, which is an inherent identifier, is created by providing the URI to the context of a space copied from a specific space using context, ontology and URN (Uniform Resource Name), and the URI (Uniform Resource Identifier).

The URI of context ontology is stored in a database by a personal context URN of a respective space copier for thereby creating a space file, and the context of a specific space is copied, edited, combined, shared or pasted using the space file.

The context copy/paste system of a space using ontology according to an embodiment of the present invention will be described.

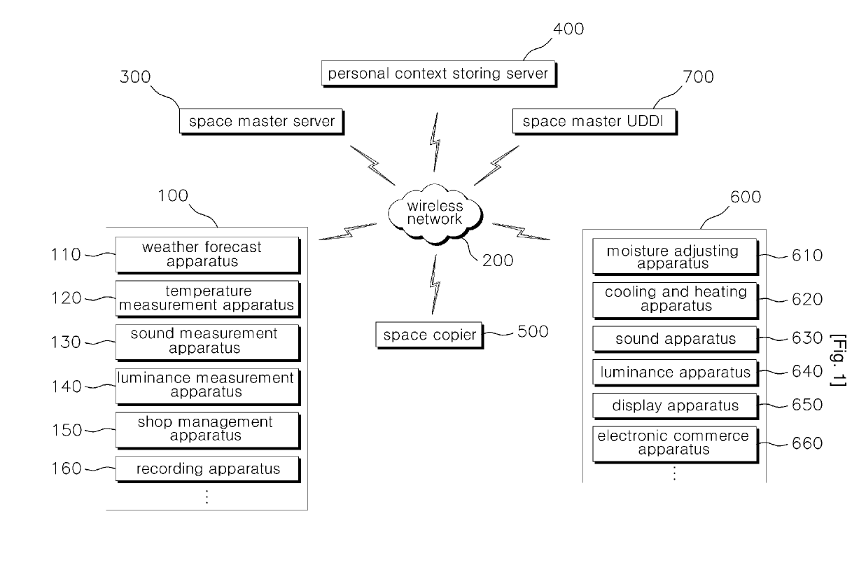

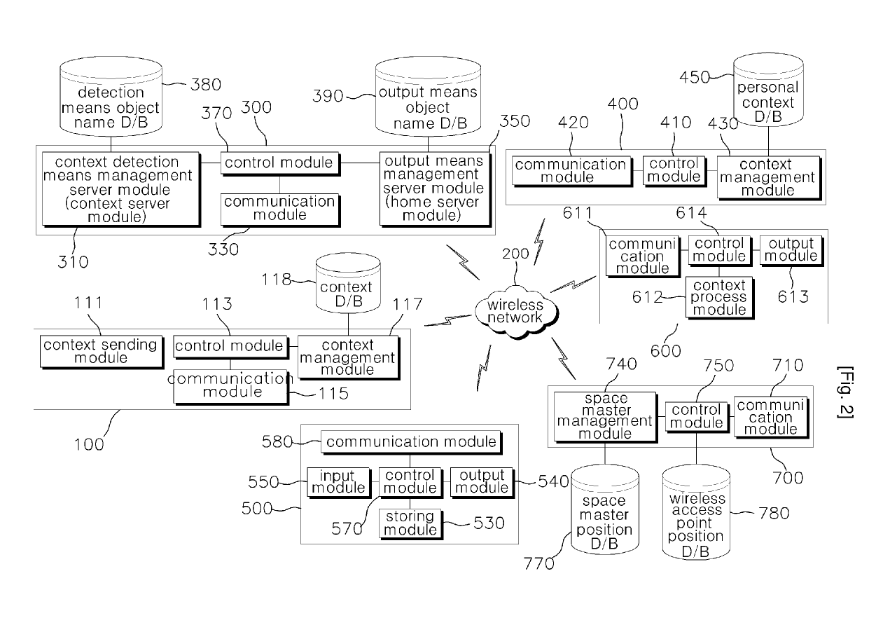

FIG. 1 is a schematic view illustrating a system for a context copy and paste method using ontology according to an embodiment of the present invention, and FIG. 2 is a view illustrating a detailed block of a context copy and paste system using ontology according to an embodiment of the present invention.

The above construction will be described in mode detail with reference to FIGS. 1 and 2.

The context copy/paste system of a space according to the present invention comprises a plurality of detection means 100, a wireless network 200, storing means 300, 400 and 700, a space copier 500 and a plurality of output means 600. The storing means comprises a space master server 300, a personal context storing server 400, and a space master UDDI 700. The above construction is not limited thereto.

The detection means 100 comprises a weather forecast apparatus 110 including a ubiquitous sensor, a temperature measurement apparatus 120, a sound measurement apparatus 130, a luminance measurement apparatus 140, a shop management apparatus 150 and a recording apparatus 160. In the detection means 100, there is provided an inherent identification number formed of one among URN and URI of context ontology, and context of a time-based specific space is sensed and transmitted to a personal context storing server 400 of the storing means. The URI of context ontology, which is an inherent identifier, is provided and stored in a database. The detection means 100 requests the context of a corresponding space stored in the database of the personal context storing server 400 is searched and transmitted to the space master server 300 of the storing means depending on a request of the space master server 300. The detection means 100 comprise a control module 113, a context sensing module 111, a context management module 117, a context D/B 118 and a communication module 115.

The control module 113 controls the following operations. Namely, the control module 113 senses a context of a time-based specific space and stores the context in the context D/B 118, and provides a URI of the context ontology, which is an inherent identifier, and transmits the context provided a URI of the context ontology to the personal context storing server 400 of the storing means, and requests the context provided the URI of the context ontology is stored in a database of the personal context storing server 400 by the URI of context ontology. The control module 113 requests the context of a corresponding specific space stored in the database of the personal context storing server 400 is searched and transmitted to the space master server 300 of the storing means depending on a request of the space master server 300.

The context sensing module 111 senses the context of a specific space and stores in the context D/B 118.

The context management module 117 provides URI of a context ontology, which is an inherent identifier, with respect to the context of the sensed specific space and manages a transmission and receipt information with the personal context storing sever 400 of the storing means or the space master server 300 of the storing means.

The context d/B 118 stores an inherent identification number of a plurality of detection means and stores the context of the specific space sensed by the context sensing module 111 and provides the context stored.

The communication module 115 provides a communication interface for a reliable communication with the space master server 300 of the storing means, the personal context storing server 400 of the storing means, or the space copier 500.

The wireless network 200 is a wireless communication network for providing a wireless communication function such as GPS, FRID, EKAW, UWB, CEL or something and uses a local and long distance wireless communication network. The detailed constriction descriptions, not matching with the purpose of the present invention, will be omitted.

The storing means 300, 400 and 700 store the context of the specific space copied from the detection means 100 positioned in a specific space into the URI of the context ontology, which is an inherent identification number of the detection means, and store the URI of the context ontology, in which the context of the specific space copied from the space copier 500 is stored, by the inherent identification number of the space copier for thereby creating or providing a space file, while operating as a server or web server. The storing means are positioned in a specific space and performs a wireless communication with the detection means 100, the output means 600 or the space copier 500. The storing means is formed of a space master server 300, a personal context storing server 400 and a space master UDDI 700. The above construction is not limited thereto. Various constructions may be possible by a person skilled in the art.

The space master server 300 is positioned in a specific space and operates as a server for coping, editing, combining, sharing or pasting the context of a specific space and has an inherent identification number and registers the inherent identification number and position information of the detection means 100 and the output means 600 and stores in the database. The information of the detection means 100 is provided depending on the position of the space copier 500.

Using the copy condition of the specific space received from the space copier 500 and the selected detection means 100, the space master server 300 requests the detection means 100 of the specific space for a copy of the context of a corresponding space, and receives the URI of the context ontology and transmits the URI of the context ontology to the personal context storing server 400.

Using the personal context URN received from the space copier 500, the space master server 300 requests a creation of a space file, in which the URI of the context ontology is stored in the database of the personal context storing server 400 by the personal context URN, which is an inherent identification number of the space copier.

As a context paste of the specific space is requested from the space copier 500, the space master server 300 searches and extracts the space file stored in the database of the personal context storing server 400 by the personal context URN using the personal context URN received from the space copier 500 and controls the output means 600 of a corresponding specific space using an output condition received from the space copier 500.

The space master server 300 comprises a control module 370, a context module 310, a home server module 350, a detection means object name D/B 380, an output means object name D/B 390, and a communication module 330.

The control module 370 controls the following operations. Using the copy condition of the specific space received from the space copier 500 and the selected detection means 100, the control module 370 requests the detection means 100 of the specific space for a copy of the context of a corresponding space, and receives the URI of the context ontology and transmits the URI of the context ontology to the personal context storing server 400, and requests a creation of a space file, in which the URI of the context ontology is stored in the database of the personal context storing server 400 by the personal context URN, which is an inherent identification number of the space copier, using the personal context URN received from the space copier 500.

As a context paste of the specific space is requested from the space copier 500, the control module 370 searches and extracts the space file stored in the database of the personal context storing server 400 by the personal context URN using the personal context URN received from the space copier 500 and controls the output means 600 of a corresponding specific space using an output condition received from the space copier 500.

The context server module 310 registers an inherent identification number and position information of the detection means 100 and stores the same into the detection means object name D/B 380. The context server module 310 searches and extracts the information of the detection means depending on a search condition such as a copy, edit, combination, sharing or paste.

The home server module 350 registers an inherent identification number and position information of the output means 600 and stores the same into the output means object name D/B 390. The home server module 350 searches and extracts the information of the output means depending on a search condition such as a copy or paste, and controls the output means 600 of a corresponding specific space depending on a control of the control module.

The detection means object name D/B 380 stores and provides an inherent identification number and position information of the detection means 100.

The output means object name D/B 390 stores and provides an inherent identification number and a position information of the output means 600.

The communication module 330 provides a communication interface for a reliable wireless communication with the detection means 100, the personal context storing server 400, the space copier 500, the output means 600 and the space master UDDI 700.

The personal context storing server 400 is a server positioned in a specific space interoperating with the space master server 300 through a wireless network and stores personal context URN of respective space copier or user-based inherent ID and password, and stores the context of a corresponding space received from the detection means 100 into the database by the URI of the context ontology which is an inherent identifier provided by the detection means 100 and stores the URI of the context ontology of a corresponding specific space copied and transmitted from the space master server 300 based on the personal context URN of the space copier for thereby creating a space file.

A space file of a corresponding specific space stored in the database is searched and extracted using the personal context URN received from the space master server 300 depending on a paste, edit or combination request and sharing request of the context of the space copier 500 and is transmitted to the space master server 300.

The personal context storing server 400 comprises a control module 410, a context management module 430, a personal context D/B 450 and a communication module 420.

The control module 410 controls the following operations. Namely, it stores the context of a corresponding space received from the detection means 100 based on the URI of the context ontology which is an inherent identifier provided by the detection means 100 and stores the URI of the context ontology of a corresponding specific space copied and transmitted from the space master server 300 into the personal context D/B 450 based on the personal context URN of the transmitted space copier 500 for thereby creating a space file. A space file of a corresponding specific space stored in the personal context D/B 450 is searched and extracted using the personal context URN received from the space master server 300 depending on a paste request, edit or combination request and sharing request of the context of the space copier 500 and is transmitted to the space master server 300.

The context management module 430 stores the URI of the context ontology of a specific space by the personal context URN depending on a context copy request of the space copier 500 for thereby creating a space file, and a space file of a corresponding specific space stored in the personal context D/B 450 using the personal context URN depending on a paste request, edit or combination request and sharing request of the context of the space copier 500, and manages the same.

The personal context D/B 450 stores a respective space copier-based personal context URN or a user-based inherent ID and password, and stores the context of a corresponding space received from the detection means 100 by the URI of the context ontology which is an inherent context provided by the detection means 100 and stores a space file in which the URI of the context ontology of a corresponding specific space copied and transmitted from the space master server 300 is stored by the personal context URN.

The communication module 420 provides a communication interface for a reliable wireless communication with the space master server 300.

The space master UDDI 700 registers and stores the information of all space master servers and searches and extracts the space master server 300 from the database to allocate the space master server 300 to the space copier 500. In the space master server 300, it is possible to copy, edit, combine, share or paste the context of a specific space using an inherent identification number of the detection means 100 positioned in a corresponding specific space received from the space copier 500.

Here, the space master UDDI 700 comprises a control module 750, a space master management module 740, a space master position D/B 770, a wireless access point position D/B 780 and a communication module 710.

The control module 750 controls the following operations. Namely, it searches and extracts the space master server 300 from the database to allocate the space master server 300 to the space copier 500. In the space master server, it is possible to copy, edit, combine, share or paste the context of a specific space using an inherent identification number of the detection means 100 positioned in a corresponding specific space received from the space copier 500.

The space master management module 740 searches and extracts the space master server 300 stored in the wireless access point position D/B 780 and the space master position D/B 770 using an inherent identification number of the detection means 100, and allocate the space master server 300 to the space copier 500.

The space master D/B 770 stores and provides the information of the entire space master server 300.

The wireless access point position D/B 780 stores and provides an inherent identification number and position information of the entire detection means 100.

The communication module 710 provides a communication interface for a reliable wireless communication with the space master server 300 and the space copier 500.

The space copier 500 is an apparatus for coping or pasting a context of a specific space using the system, which is able to copy a context of the same space, and a context copy and paste method of the space. It includes a mobile communication terminal such as PCS, cellular phone, PDA or something, a wireless communication manufactured in a fountain pen shape for an easier portability, and a communication terminal with a memory. It also includes a program adapted with an algorithm for coping, editing, combining, sharing or pasting the context of the space.

The space copier 500 of the present invention includes an inherent identification number which is called as URN. It is possible to paste a context of a specific space by outputting the space file of a specific space stored by the URN, which is an inherent identification number, in the storing means 300 to the outside through the various output means 600.

In more details, the space copier 500 has a personal context URN which is an inherent identification number, senses an inherent identification number of the nearest detection means 100 and transmits the inherent identification number of the nearest detection means 100 to the storing means.

The space copier 500 has an allocation of the space master server 300 (or space agent) of a corresponding specific region in which a copy, edit, combination, sharing or paste is possible from the storing means and receives information of the detection means 100 which senses a context of a corresponding specific space, which will be copied or pasted, from the space master server 300. The space copier 500 transmits copy or paste condition, selected detection means and personal context URN to the space master server 300, and requests a copy or paste of a context of a specific space.

The space copier of the present invention will be described in more detail with reference to FIG. 2.

The space copier 500 comprises a control module 570, a communication module 580, a storing module 530, an output module 540 and an input module 550.

The control module 570 controls the following operations. Namely, an inherent identification number of the nearest detection means is sensed and transmitted to the storing means depending on a signal of a copy, edit, combination, sharing or paste from the input module 550, and the space master server 300, which is a storing means of a corresponding specific region, is allocated. In the space master server 300, it is possible to copy, edit, combine, share or paste the context of a corresponding specific space using an inherent identification number of the detection means 100. An information of the detection means for sensing a context of a corresponding specific space to be copied, edited, combined, shared or pasted from the space master server 300 of the storing means is received, and a copy or paste condition and selected detection means and inherent identification number are transmitted to the space master server 300 of the storing means, and a context of a corresponding specific space is requested to be copied or pasted.

The input button 550 provides a character or symbol type button for generating an input signal so that a user can copy, edit, combine or share the context of a specific space and can select a context attributer and can paste a context of the copied specific space to the specific space.

The user module 530 stores a personal context URN, which is an inherent identification number of the space copier, and a program needed for driving space copier and further includes a program with an algorithm for coping, editing, combining, sharing or pasting a context of a specific space.

The output module 540 receives information of the detection means, which senses a context of a corresponding specific space, and performs a display function for selecting a copy, edit, combination, sharing, pasting condition or a detection means.

The communication module 520 provides a communication interface for performing a reliable wireless communication with the detection means 100 or the storing means.

The output means 600 are provided in a specific space such as home, office or something and comprise a display apparatus 650 for externally outputting or displaying a context of a specific space, a moisture adjusting apparatus 610, a cooling and heating apparatus 620, a sound apparatus 630, a lighting apparatus 640, an electronic commerce apparatus 660, an air conditioner, a boiler or something. Namely, it outputs a context of a specific space for pasting a corresponding specific space depending on a context at the time of copy in accordance with a control of the space master server 300 of the storing means. Here, the output means 600 further comprise a control module 614, an output module 613, a context process module 612 and a communication module 611.

The control module 614 controls the following operations. Namely, various contexts are adjusted and outputted to the outside depending on the context when copying a corresponding specific space through the output means 600 of a specific space for receiving and pasting the context of a specific space received from the space master server 300 in accordance with a control of the space master server 300.

The context process module 612 interprets a context of the URI of the context ontology depending on a condition for pasting a context of a specific space received from the space master server 300 and transmits a control value to the output module 613 and outputs various contexts to the outside and controls the same.

The output module 613 directly outputs a certain context corresponding to a context of a specific space to the outside depending on an output and adjustment of the context by receiving a control value of the context process module.

The communication module 611 provides a communication interface for performing a reliable wireless communication with the space master server 300.

The operations of a context copy/paste system using ontology, and the operations of a context copy/paste method, and a space copier using the same according to the present invention will be described with reference to the accompanying drawings.

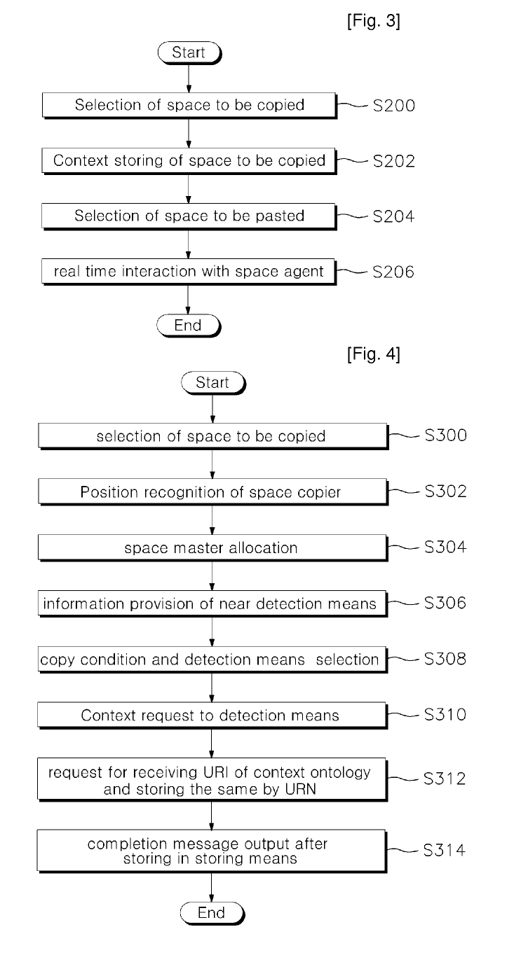

FIG. 3 is a flow chart of a context copy and paste method using ontology according to an embodiment of the present invention. FIG. 6 is a view illustrating a state that a context using ontology is copied and pasted in an augmented reality according to an embodiment of the present invention.

As shown in FIGS. 3 and 6, a context is sensed at every time through the detection means 100 positioned in a specific space, and the context sensed at every time is stored in the storing means using the URI of the context ontology which is an inherent identification number by the detection means.

During the above process, when a user needs to copy a context of a specific space, the copy button of the space copier is pressed for requesting a copy in a step S200. When a copy signal of a space copier positioned in a specific space to be copied is inputted, a position information of the space copier is recognized, and transmitted to the storing means.

Namely, when a copy signal of a space copier positioned in a specific space to be copied is inputted, a position information of the space copier is recognized, and transmitted to the storing means.

When a copy signal of the space copier positioned in the specific space to be copied is inputted, a wireless communication is performed with the detection means 100 nearest the space copier 500 for thereby sensing an inherent identification number of the detection means, and the inherent identification number of the sensed detection means is transmitted to the storing means.

The storing means judges the position information of the space copier using an inherent identification number of the received detection means and allocates a space agent of the storing means which is able to copy the context of the specific space, and the space agent searches and extracts all information of the detection means of the space having the space copier 500 and transmits the information to the space copier 500.

When the space copier 500 selects the detection means 100 for coping the context of the specific space in the information of the received detection means, and inputs a copy condition such as temperature, moisture, luminance or copy radius, an inherent identification number of the space copier, and the selected detection means and the copy condition transmitted to the space agent of the storing means.

The space agent of the storing means receives a context through the detection means 100 positioned in a specific space to be copied depending on the inherent identification number of the received space copier, the selected detection means and the copy condition and stores in the storing means based on the inherent identification number of the space copier and the inherent identification number of the detection means for thereby creating a space file in a step S202.

The context of the specific space is stored in the storing means and a space file is created. When a user requests a paste by pressing the paste button through the space copier for pasting a space file of the stored specific space in a step S204, the space copier 500 generates a paste signal.

Namely, when a paste signal of a space copier positioned in a specific space is inputted, a position information of the space copier is recognized, and transmitted to the storing means.

When a paste signal of the space copier positioned in the specific space to be pasted is inputted, a wireless communication is performed with the detection means 100 nearest the space copier 500 for thereby sensing an inherent identification number of the detection means, and the inherent identification number of the sensed detection means is transmitted to the storing means.

The storing means judges the position information of the space copier using an inherent identification number of the received detection means and allocates a space agent of the storing means which is able to paste the context of the specific space.

The space agent of the storing means searches and extracts a space file of the specific space stored in the storing means by coping the position information of the space copier and the output means 600 positioned in a space to be pasted, and the space agent analyzes the space file of the extracted specific space and transmits a control value to the extracted output means 600, and the context of the stored specific space is outputted to the outside in a step S206.

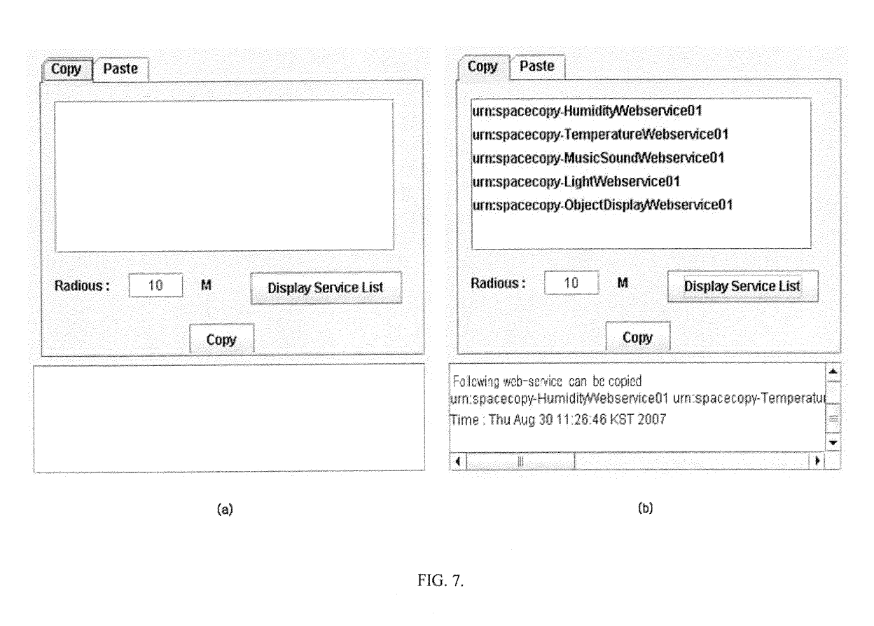

FIG. 4 is a detailed flow chart of a context copy method using ontology according to an embodiment of the present invention, and FIG. 7 is a view illustrating a process that a context using ontology is copied using a space copier according to an embodiment of the present invention.

The method for coping a context of the space will be described with reference to FIGS. 4 and 7.

The detection means 100, the context detection apparatuses 110, 120, 130, 140, 150 and 160 sense the context of a specific space at every time, and provide the URI of the context ontology, which is an inherent identifier, with respect to the context of the specific space.

The URI of the context ontology is transmitted to the personal context storing server 400 of the storing means by means of the wireless network 200, and stored depending on the URI of the context ontology, which is an inherent identifier by the detection means.

When the user wants to copy a context of a specific space under the above conditions, the user presses the copy button using the space copier 500 formed in a shape of a cellular phone or fountain pen in a step S300.

The space copier 500 senses an inherent identification number of the nearest detection means by performing a communication with the surrounding detection means 100 depending on a signal generated as the copy button of the space copier is pressed, and the inherent identification number of the sensed detection means is transmitted to the space master UDDI 700 of the storing means in a step S302.

The space master UDDI 700 searches and extracts the space master server 300, which is a space agent of a corresponding specific space, so that a context of a space is copied in a corresponding space copier 500 using an inherent identification number of the received detection means and allocates the space master server 300 to the space copier 500. The position information of the space copier 500 is searched and extracted using an position information of the received detection means, and transmitted to the space master server 300. The context is copied by means of the space master server 300 which is a space agent in a step S304.

The space master server 300 of a corresponding specific space which is an agent allocated to the space copier 500 transmits the information of all the detection means of a corresponding specific space using the position information of the received space copier 500 to the space copier 500 as shown in FIG. 7, and the space copier 500 displays the information of the detection means which sense the context information of a corresponding specific space, so that the user can check, and allows the copy condition such as a temperature, moisture, luminance, image or radius of a specific space to be copied and detection means to be selected in a step S306.

When a user selects a copy condition or a detection means, the space copier 500 transmits information of the selected detection means, a copy condition and a personal context URN of the space copier to the space master server 300.

The space master server 300 requests a context of a specific space to the detection means 100 of the received specific space in a step S310, and searches and extracts and receives the URI of the context ontology of a corresponding context depending on a request of the detection means.

The personal context URN received from the space copier 500 and the URI of the context ontology are transmitted to the personal context storing server 400. Here, the URI of the context ontology of a corresponding context is sensed at every time and stored by the inherent identification number of the detection means at the personal context storing server 350

The personal storing server 400 stores the URI of the context ontology into the database by the context URN of the received space copier for thereby creating a space file in a step S312.

When the storing is finished, a completion message is outputted to the space copier 500, and the context copy process of the specific space is completed in a step S314.

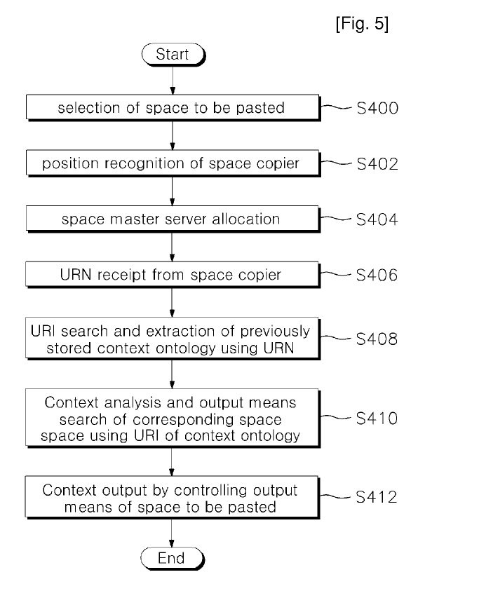

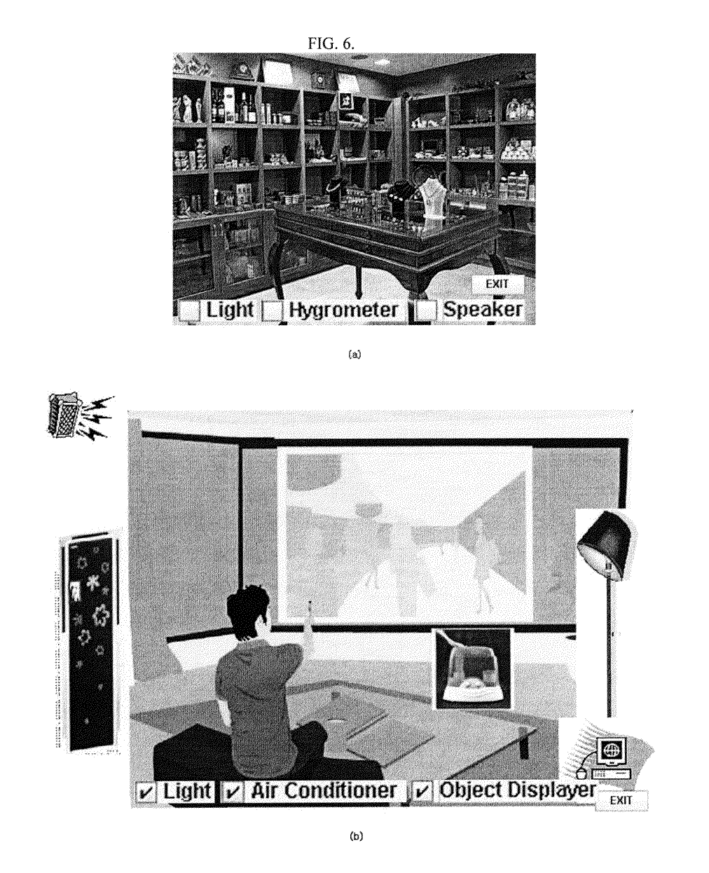

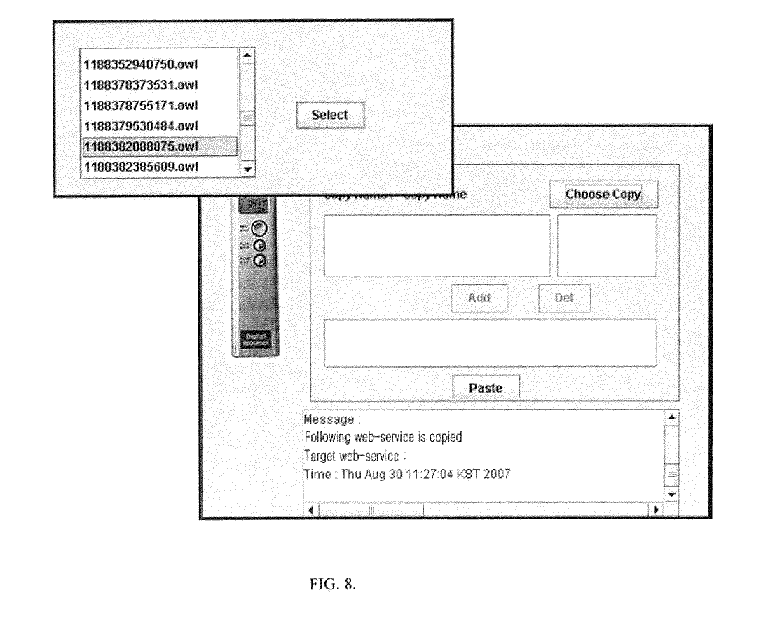

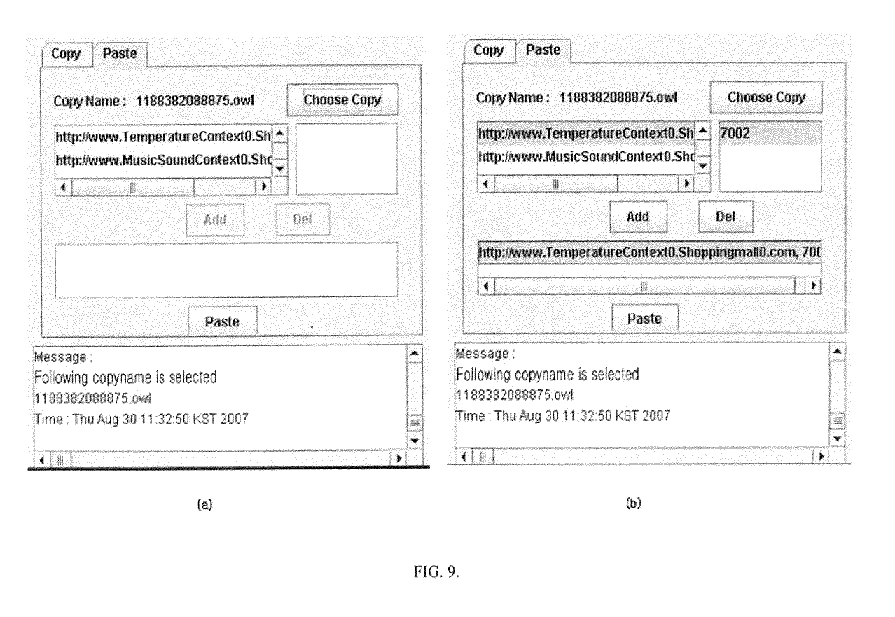

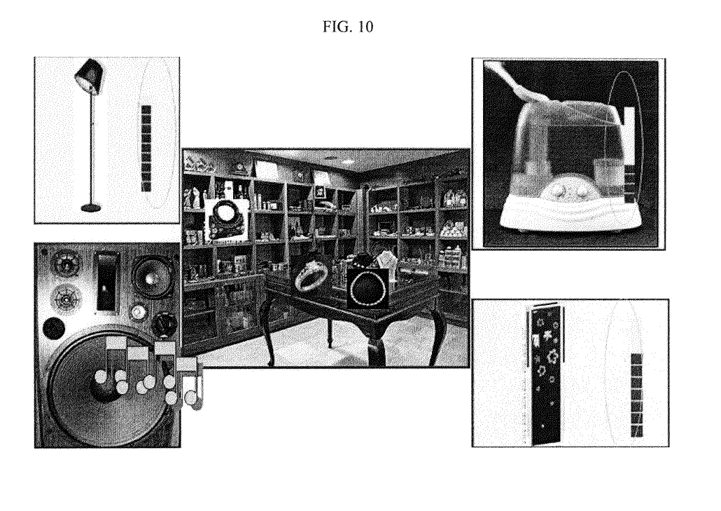

FIG. 5 is a detailed flow chart of a context paste method using ontology according to an embodiment of the present invention. FIG. 8 is a view illustrating a list of a space file copied for pasting a context using ontology according to an embodiment of the present invention. FIG. 9 is a view illustrating a context of a space file selected selected among the copied space files for pasting a context using ontology according to an embodiment of the present invention. FIG. 10 is a view illustrating an example of an output means which outputs a context to the outside after pasting a context using ontology to the output means according to an embodiment of the present invention.

The method for pasting a context of a space according to the present invention will be described with reference to FIG. 5, FIG. 8, FIG. 9 and FIG. 10.

As shown in FIG. 4, when a user presses a paste button of the space copier 500 for pasting a space file of a specific space stored in the personal context storing server 400 of the storing means in a step S400, the space copier 500 performs a wireless communication with the surrounding detection means 100 depending on a signal of the paste button of the space copier for thereby sensing an inherent identification number of the nearest detection means, and the inherent identification number of the sensed detection means and the inherent identification number of the space copier are transmitted to the space master UDDI 700 of the storing means in a step S402.

The space master UDDI 700 searches and extracts the space master server 300 which is a space agent of a corresponding specific space for pasting a context of the space into a corresponding space copier 500 using an inherent identification number of the received detection means and allocates the space master server 300 to the space copier 500, and the position information of the space copier 500 is searched and extracted and transmitted to the space master server 300 which is a space agent. The context is pasted by means of the space master server 300 which is a space agent in a step S404.

The space master server 300 requests a space file of the specific space stored in the personal context storing server 400 of the storing means using the personal context URN of the received space copier in a step S406. The personal context storing server 400 searches and extracts the space file including the URI of the context ontology using the personal context URN which is an inherent identification number of the received space copier and transmits the space file to the space master server 300 in a step S408.

The space master server 300 searches and extracts a context of the specific space stored by the URI of the context ontology in the personal context storing server 400 using the URI of the context ontology of the received space file and analyzes the context of the received specific space and confirms the output means 600 of the specific space used for pasting in a step S410.

In the above steps, as shown in FIG. 8, the space master server 300 transmits the space file (for example, the file having an extension of owl as shown in FIG. 8) to the space copier 500. When the user selects a space file, as shown in FIG. 9, one among the contexts of the space file is selected, so that it is possible to receive a context of a corresponding space file depending on the selection of the user.

The space master server 300 adjusts a context of a corresponding specific space depending on the context when coping to the specific space to be pasted, and transmits the control value to the output means 600. As shown in FIG. 10, the output means 600 output the context of the specific space copied and stored using the received context to the outside for thereby pasting the context of the copied specific space in a step S412.

Here, the control values used for adjusting the output means are formed in directional vectors.

In the present invention, at least one or more space files which stored the context of the specific space are used by edit or combination, and a third party can use at least one or more space file by sharing the space file.

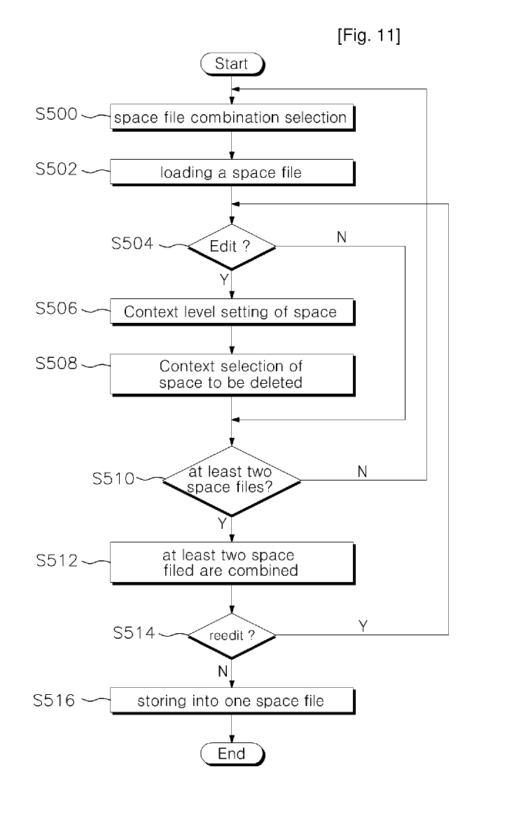

FIG. 11 is a view illustrating a method for editing or combining the context of the space using ontology according to an embodiment of the present invention. The method for editing or combining the space file will be described in detail.

When the combining button of the space copier 500 is pressed for editing or combining the space file stored in the personal context storing server 400, the space copier 500 performs a wireless communication with the communication module 115 of the detection means 100 positioned in a surrounding portion depending on the signal related with the combining button of the space copier and senses the inherent identification number of the nearest detection means 100, and the inherent identification number of the sensed inherent means is transmitted to the space master UDDI 700.

The space master UDDI 700 searches and extracts the space master server 300 which is able to edit or combine the context of the space to a corresponding space copier 500 using the inherent identification number of the received detection means and allocates the space master server 300 to the space copier 500, and the space copier 500 transmits the personal context URN, which is an inherent identification number, to the space master server 300.

The space master server 300 requests a plurality of space files having the contexts of a specific space previously stored in the personal context storing server 400 using the personal context URN of the received space copier, and the space master server 300 transmits a plurality of space files received from the personal context storing server 400 to the space copier 500, and the space copier 500 stores the space files and displays through the output module 540 of the space copier in a step S500.

When at least one is selected among the displayed space files for edit or combination, the space copier 500 transmits the selected space file information and the personal context URN to the space master server 300, and the space master server 300 transmits the received space file information and the personal context URN to the personal context storing server 400 for thereby requesting a context of a corresponding space file.

The personal context storing server 400 searches and extracts a context of a specific space stored in the URI of the context ontology using the information of the received space file and the personal context URN and transmits the context of a specific space to the space master server 300, and the space master server 300 transmits the context of a specific space to the space copier 500 in a step S502.

The space copier 500 displays the context of the received specific space. When the user selects the edit in a step S504, it is possible to set the level of each context to be outputted to the output means of a specific space using the input module 550 of the space copier. Namely, it is possible to amend the values of a temperature adjustment, moisture adjustment, sound adjustment, size adjustment of the space or something depending on the specific space in which the context information such as temperature, moisture, sound, size of space or something of the originally copied specific space, and it is possible to arrange or decorate in a desired way of a user in a step S506. If necessary, it is possible to delete the context of the specific space. When the above edit is completed, the context of a corresponding space file is temporarily stored in the storing module 530 of the space copier in a step S508.

When the user does not select the edit, the routine goes to directly the step S510 or after the edit process a step S510 is performed. It is judged whether there are at least two space files in a step S510. When there are at least two space files to be edited or combined, the contexts of corresponding space files are combined and displayed through the output module 540 of the space copier 540 in a step S512. When the space files are less than two, the routine is performed from the step S500 so that at least one space file is selected for combining the same.

In the step S514, when the reedit is selected upon checking the context of a corresponding space file combined and displayed in the step S512, the routine is performed from the space 5504. When the reedit is not selected in a step S514, the space copier 500 stores the context of at least two edited or combined space files in one space file, and the space file combined with the inherent identification number of the space copier 500 is transmitted to the space master server 300, and the space master server 300 is transmitted to the personal context storing server 400.

The personal context storing server 400 amends the context of the specific space stored by the URI of the context ontology previously stored by means of the detection means 100 using the inherent identification number of the received space copier and the space file, and the amended space file is stored in the personal context D/B 450 of the personal context storing server by the inherent identification number of the space copier in a step S516.

The stored space file is transmitted to the output means 600 in accordance with a paste signal of the space copier, and the context of the specific space is outputted to the outside.

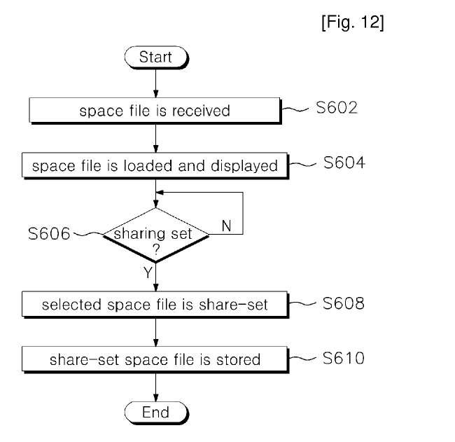

FIG. 12 is a view of a method for sharing a context of a space using ontology according to an embodiment of the present invention. The method for sharing a space file will be described with reference to FIG. 12.

When the sharing button of the space copier 500 is pressed for share-setting the space file in which the context of the specific space stored in the personal context storing server 400 is stored, the space copier 500 performs a wireless communication with the communication module 115 of the detection means 100 positioned in a surround portion depending on the signal related to the sharing button of the space copier and senses the inherent identification number of the nearest detection means 100, and the inherent identification number of the sensed detection means is transmitted to the space master UDDI 700.

The space master UDDI 700 searches and extracts the space master server 300 which is a space agent able to editing or sharing the context of the space in a corresponding space copier 500 using the inherent identification number of the received detection means and allocates the space master server 300 to the space copier 500. The space copier 500 extracts the personal context URN which is an inherent identification number, and transmits the personal context URN to the space master server 300.

The space master server 300 requests a plurality of space files having the context of the copied specific space previously stored in the personal context storing server 400 using the personal context URN of the received space copier, and the space master server 300 transmits the space files received from the personal context storing server 400 to the space copier 500 in a step S602, and the space copier 500 stores the received space files and displays through the output module in a step S604.

When at least one space file among the displayed space files to be share-set is selected in a step S606, the space copier 500 transmits the selected space file information and the personal context URN to the space master server 300, and the space master server 300 transmits the received space file information and the personal context information URN to the personal context storing server 400 for thereby requesting a sharing setting of a corresponding space file in a step S608.

The personal context storing server 400 searches and extracts the context of a specific space stored in the URI of the context ontology in the personal context D/B 450 using the received space file information and the personal context URN and provides to a third party.

The sharing setting information is transmitted to the space master server 300, and the space master server 300 displays a state that at least one space file selected by the user is share-set by transmitting to the space copier 500 in a step S610.

The thusly share-set space file information is displayed in the space copier 500 in accordance with a paste signal of the space copier in order for the third party to select the same. The selected space file is transmitted to the output means 600, and the context of the specific space is outputted to the outside.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

### INDUSTRIAL APPLICABILITY

As described above, in the space context copy/paste method and system using ontology, and a space copier using the same according to the present invention, the contexts needed for recognizing the surrounding environments in the ubiquitous environment are stored in a database through various detection means, and it is possible to copy and paste the contexts of various spaces through a portable space copier. The present invention may be well adapted to an electronic commerce, a weather information provision service, a position information provision service, a financial transaction, the same space implementation or something.

### SEQUENCE LISTING

ontology, space, copier, copy, paste, electronic commerce

1. In a context copy method of a space using a detection means, a storing means, an output means and a space copier under a ubiquitous environment, a context copy/paste method of a space using ontology, comprising:
a step (a) in which when a copy signal of a space copier positioned in a specific space to be copied is inputted, a position information of the space copier is recognized, and transmitted to the storing means;
a step (b) in which the storing means, which received the position information of the space copier, receives a context through the detection means positioned in the specific space to be copied, and stores the context as a space file;
a step (c) in which when a paste signal of the space copier positioned in the specific space to be pasted is inputted, the position information of the space copier is recognized, and transmitted to the storing means; and
a step (d) in which the storing means, which received the position information of the space copier, searches and extracts the space file formed of the context of the specific space and an output means positioned in the space to be pasted, and outputs the context of the previously stored specific space to the outside through the extracted output means.

2. The method of claim 1, wherein said step (a) includes:
a step (a-1) in which when a copy signal of the space copier positioned in the specific space to be copied is inputted, a wireless communication is performed with the detection means nearest the space copier for thereby sensing an inherent identification number of the detection means; and
a step (a-2) in which the inherent identification number of the sensed detection means is transmitted to the storing means.

3. The method of claim 1, wherein said step (b) includes:
a step (b-1) in which the storing means allocates a space agent able to copy the context of a specific space using the position information of the space copier, and all the information of the detection means of the space, in which the space copier is positioned, is transmitted to the space copier by means of the space agent;
a step (b-2) in which when a detection means for coping the context among the information of the received detection means is selected, and the copy condition is inputted, an inherent identification number of the space copier, the selected detection means and copy condition are transmitted to the space agent; and
a step (b-3) in which the space agent, which received the inherent identification number of the space copier, the selected detection means and copy condition, receives a context through the detection means positioned in specific space to be copied, and creates a space file by the inherent identification number of the space copier, and stores the same in the storing means.

4. The method of claim 3, wherein said step (b-3) includes:
a step (b-31) in which said space agent, which received the inherent identification number of the space copier, the selected detection means and copy condition, requests a context sensed through the selected detection means and receives a context of the specific space previously stored in the storing means; and
a step (b-32) in which the context of the received specific space is created as a space file by the inherent identification number of the received space copier, and the space file is stored in the storing means.

5. The method of claim 3, wherein said inherent identification number of the space copier is either URN or URI.

6. The method of claim 1, wherein said step (c) includes:
a step (c-1) in which when a paste signal of the space copier positioned in a specific space to be pasted is inputted, a wireless communication with the detection means nearest the space copier is performed for thereby sensing an inherent identification number of the detection means; and
a step (c-2) in which the inherent identification number of the sensed detection means is transmitted to the storing means.

7. The method of claim 1, wherein said step (d) includes:
a step (d-1) in which the space agent of the storing means which received the position information of the space copier searches and extracts the space file formed of the context of the specific space and an output means positioned in the space to be pasted; and
a step (d-2) in which the space file formed of the context of the extracted specific space is analyzed, and a control value is transmitted to the output means, and the context of the previously stored specific space is outputted to the outside.

8. The method of claim 7, wherein said control value is a directional vector.

9. The method of claim 1, wherein said context of the specific space is provided with an URI of a context ontology which is an inherent identification number of the detection means.

10. The method of claim 1, wherein said context of the specific space is stored in the storing means by time and the URI of the context ontology, which is an inherent identifier provided by the detection means.

11. The method of claim 1, wherein said step (b) or step (c) includes:
a step (1) in which said space copier or user terminal loads and displays at least one space file stored in the storing means;
a step (2) in which at least one space file among the space files loaded and displayed on the space copier or the user terminal is edited or combined as one space file and is temporarily stored; and
a step (3) in which the temporarily stored space file is stored in the storing means.

12. The method of claim 11, wherein said step (1) includes:
a step (1-1) in which when a combination signal of the space copier positioned in the specific space to be copied is inputted, a wireless communication with the detection means nearest the space copier is performed, and the inherent identification number of the space copier is transmitted to the storing means; and
a step (1-2) in which a space file previously stored in the storing means is searched and extracted using an inherent identification number of the received space copier and is transmitted to the space copier.

13. The method of claim 11, wherein said space file is formed of the contexts of at least one specific space and is stored in the space copier or the storing means by means of the space copier.

14. The method of claim 11, wherein said step (2) includes:
a step (2-1) in which at least one space file loaded in the space copier or the user terminal is displayed;
a step (2-2) in which when a user selects the displayed space file, the context of the selected corresponding space file is displayed, and at least one context is edited or combined depending on the selection of a user;
a step (2-3) in which at least one context selected by the user is edited or combined and is temporarily stored in one space file, and at least another space file is displayed to the user;
a step (2-4) in which when the user selects other space files in the step (2-3), the steps (2-2 and 2-3) are performed, and the temporarily space file and the edited or combined space file are combined into one file, and the file is stored; and
a step (2-5) in which when the user does not select the other space file in the step (2-3), the temporarily stored space file is last combined and stored.

15. The method of claim 11, wherein said step (3) includes:
a step (3-1) in which an inherent identification number of the space copier is provided to one space file which is edited or combined and temporarily stored; and
a step (3-2) in which the space file with the inherent identification number is transmitted to the storing means and is stored by the inherent identification numbers of the space copier.

16. The method of claim 1, wherein said step (b) or step (c) includes:
a step (A) in which the space copier or user terminal loads at least one space file stored in the storing means;
a step (B) in which when a user selects at least one space file loaded and displayed in the space copier or user terminal, it is set so that the information of the selected space file is shared, and is temporarily stored; and
a step (C) in which the temporarily stored space file is stored in the storing means.

17. The method of claim 16, wherein said step (A) includes:
a step (A-1) in which when a sharing signal of the space copier positioned in the specific space to be copied is inputted, a wireless communication with the detection means nearest the space copier is performed, and the inherent identification number of the space copier is transmitted to the storing means; and
a step (A-2) in which a space file previously stored in the storing means is searched and extracted using an inherent identification number of the received space copier and is transmitted to the space copier.

18. The method of claim 16, wherein said step (B) includes:
a step (B-1) in which at least one space file loaded in the space copier or user terminal is displayed;
a step (B-2) in which when a user selects the displayed space file, a context of a corresponding space file is displayed, and at least one space file is shared depending of the selection of a user;
a step (B-3) in which at least shared space file is temporarily stored depending on the selection of a user, and at least another space file for sharing is displayed to the user;
a step (B-4) in which when a user selects the other space files in the step (B-3), the steps (B-2 and B-3) are performed, and the temporarily stored space file and added shared space file are stored; and
a step (B-5) in which when the user does not select the other space file in the step (B-3), the temporarily stored space file is last shared and stored.

19. The method of claim 16, wherein said step (C) includes:
a step (C-1) in which an inherent identification number of the space copier is provided to one space file which is shared and temporarily stored;
a step (C-2) in which the space file with the inherent identification number is transmitted to the storing means and is stored by the inherent identification numbers of the space copiers.

20. In a system which includes a detection means for detecting at least one context under a ubiquitous environment, a storing means, a space copier and an output means, a context copy/paste system of a space using ontology, comprising:
a plurality of detection means which have inherent identification numbers and store database by providing the URI of the context ontology, which is an inherent identifier, after sensing the context of the time-based specific space, and request the context of a corresponding space stored in the database is searched and transmitted to the storing means depending on the request of the storing means;
a storing means which stores an inherent identification number, a user-based ID and password, and registers the inherent identification numbers and position information of the detection means, output means and space copier, and stores the same in a database, and provides the information of the detection means depending on the position of the space copier, and requests a copy of the context of a corresponding space to the detection means of the specific space using a copy condition of the specific space received from the space copier or the selected detection means, and stores into a database by the inherent identification numbers received from the space copier for thereby creating a space file, and searches and extracts a space file of the specific space coped and stored in the database using the inherent identification number received depending on a context paste request in the specific space from the space copier, and controls the output means of a corresponding specific space using the output condition received from the space copier;
a space copier which has an inherent identification number, and senses an inherent identification number of the nearest detection means, and transmits the inherent identification number to the storing means, and receives the information of the detection means which senses a context of a corresponding specific space to be copied or pasted, and transmits a copy or paste condition, a selected detection means and inherent identification number to the storing means, and requests a copy or paste of the context of a corresponding specific space; and
a plurality of output means which output the context of a specific space to be pasted depending on the context when copying a corresponding specific space to the outside in accordance with a control of the storing means.

21. The system of claim 20, wherein said detection means includes:
a control module for controlling the operations that a context of a time-based specific space is sensed and provided with an URI of the context ontology, which is an inherent identifier, and is stored in a context D/B, or is transmitted to the storing means and stored in a database of the storing means by the URI of the context ontology, and a context of a corresponding specific space previously stored in the context D/B is searched and transmitted to the storing means;
a context sensing module which senses the context of a specific space and stores into the context D/B;
a context management module which provides a URI of the context ontology, which is an inherent identifier, with respect to the context of the sensed specific space and manages the transmission and receipt information with the storing means;
a context D/B which stores the inherent identification number and stores a context of a specific space sensed by the context sensing module; and
a communication module which provides a communication interface for a reliable wireless communication.

22. The system of claim 20, wherein said storing means includes:
a space master server which has an inherent identification number, and registers the inherent identification and position information of a plurality of the detection means and output means, and stores the same in a database, and provides the information of the detection means depending on the position of the space copier, and requests a copy of the context of a corresponding space to the detection means of the specific space using the copy condition of a specific space received from the space copier and the selected detection means, and receives the URI of the context ontology and transmits the URI of the context ontology to the personal context storing server, and requests that the personal context storing server store the same in a database of the personal context storing server using the inherent identification number received from the space copier and create a space file, and searches and extracts the space file copied and stored in the database of the personal context storing server using the inherent identification number received depending on the paste request of the context in the specific space from the space copier, and controls the output means of a corresponding specific space using an output condition received from the space copier;
a personal context storing server which stores an inherent number by the space copiers or an inherent ID and password by the users, and stores the context of a corresponding space received from the detection means by the URI of the context ontology which is an inherent identifier provided by the detection means, and creates a space file by storing the URI of the context ontology of a corresponding specific space copied and transmitted from the space master server into a database by the inherent identification numbers of the space copier transmitted together, and searches and extracts a space file of a corresponding specific space previously stored in the database using the inherent identification number received from the space master server depending on a context paste request of the space copier, and transmits the space file to the space master server; and
a space master UDDI which registers and stores the information of all the space master severs, and searches and extracts the space master server able to copy or paste the context of a specific space using the inherent identification number of the detection means positioned in a corresponding specific space received from the space copier, and allocates the space master server to the space copier.

23. The system of claim 22, wherein said space master server comprises:
a control module which controls the operations that a copy of the context of a corresponding space is requested to the detection means of a specific space using a copy condition of a specific space received from the space copier and the selected detection means, and the URI of the context ontology is received and transmitted to the personal context storing server, and is stored in a database by the inherent identification numbers received from the space copier for thereby creating a space file, and a space file copied and stored in the database of the personal context storing server is searched, extracted and received using a received inherent identification number depending on a paste request of a context in the specific space from the space copier, and the output means of a corresponding specific space is controlled using an output condition received from the space copier;
a context server module which registers an inherent identification number and position information of a plurality of detection means, and stores in a detection means object name D/B, and searches and extracts a detection means information in accordance with a search condition such as a copy or paste and provides and manages the same;
a home server module which registers an inherent identification number and position information of a plurality of output means, and stores in an output means object name D/B, and searches and extracts an output means information depending on a search condition such as a copy or paste, and adjust an output of the output means of a corresponding specific space in accordance with a control of the control module and manages the same;
a detection means object name D/B which stores an inherent identification number and position information of a plurality of detection means;
an output means object name D/B which stores an inherent identification number and position information of a plurality of output means; and
a communication module which provides a communication interface for performing a reliable communication.

24. The system of claim 22, wherein said personal context storing server includes:
a control module which controls the operations that a context of a corresponding space received from the detection means is stored by the URI of a context ontology which is an inherent identifier provided by a detection means, and the URI of the context ontology of a corresponding specific space copied and transmitted from the space master server is stored in the personal context D/B by the inherent identification numbers of the space copier transmitted together, and a space file is created, and a space file of a corresponding specific space previously stored in the personal context d/B is searched and extracted using a personal context URN received from the space master server depending on a request of a context paste of the space copier, and it is transmitted to the space master server;
a context management module which stores the URI of a context ontology of a specific space by the inherent identification numbers depending on a copy request of the context of the space copier, and searches and extracts a space file of a corresponding specific space file previously stored in the personal context D/B using the personal context URN depending on a paste request of the context of the space copier, and provides and manages the same;
a personal context D/B which stores an inherent identification number by the space copiers or an inherent ID and password by the users, and stores the context of a corresponding space received from the detection means by the URI of the context ontology which is an inherent identifier provided by the detection means, and stores the URI of the context ontology of a corresponding specific space copied and transmitted from the space master server by the inherent identification numbers; and
a communication module which provides a communication interface for a reliable wireless communication.

25. The system of claim 22, wherein said space master UDDI includes:
a control module which controls the operations that a space master server able to copy or paste a context of a specific space is searched and extracted using an inherent identification number of the detection means positioned in a corresponding specific space received from the space copier and is allocated to the space copier;
a space master management module which searches and extracts a space master server able to copy or paste a space file of a specific space previously stored in a wireless access point position D/B and a space master position D/B using an inherent identification number of the received detection means and allocates and manages the same;
a space master position D/B which stores the information of all the space master servers;
a wireless access point position D/B which stores an inherent identification number and a position information of all the detection means; and
a communication module which provides a communication interface for a reliable wireless communication.

26. The system of claim 20, wherein said output means includes:
a control module which outputs a context of a specific space to be pasted depending on a context when coping a corresponding specific space in accordance with a control of the space master server to the outside;
a context process module which adjusts a context of a URI of a context ontology in accordance with a condition for pasting a context of a specific space received from the space master server and transfers an output value to the output module;
an output module which outputs an information corresponding to a context of a specific space to the outside in accordance with an output and adjustment of the context process module; and
a communication module which provides a communication interface for performing a reliable wireless communication.

27. The system of one among claims 21, 23 through 26, wherein said communication module performs a wireless communication by using at least one selected from GPS, RFID, EKAW, UWB, CELL, bluetooth, and Zigbee.

28. The system of claim 20, wherein said context includes a physical information such as at least one space object, luminance, temperature, sound, smell, shape, color, size or something as well as a psychological information such as psychological anxiety, impatience, happiness, angry or something.

29. The system of claim 20, wherein said inherent identification number of the detection means is either URN or URI of the context ontology.

30. The system of claim 20, wherein said inherent identification number of the space copier is either URN or URI of the context ontology.

31. In a context copy/paste system which uses a detection means for detecting at least one context under a ubiquitous environment, a storing means and an output means, a space copier using a context copy/paste method using ontology further comprising:
a space copier which has an inherent identification number, and creates a space file by the inherent identification numbers by copying a context of a specific space sensed from the detection means, and requests the space file storing into the storing means, and requests an output the space file stored in the storing means by the inherent identification numbers through the output means

32. The copier of claim 31, wherein said space copier creates another space file by editing or combining at least one space file stored in the storing means or share-sets at least one space file stored in the storing means.

33. The copier of claim 31, wherein said space copier includes:
a control module which controls the operations that an inherent identification number of the nearest detection means is sensed in accordance with an input signal of a copy or paste, and a storing means able to copy the context of a corresponding specific space is allocated using an inherent identification number of the detection means, and a copy condition, selected detection means and inherent identification number are transmitted to the storing means by receiving the information of the detection means which detects a context of a corresponding specific space to be copied from the storing means, and a space file formed of a context of a corresponding specific space is created and stored;
an input module which provides the contexts of a specific space in a character shape or a symbol shape for a copy, paste, combination, edit, sharing, context information attribute of a specific space or a detection means selection;
a storing module which stores a program needed for driving an inherent identification number of the space copier and a space copier;
an output module which receives the information of a detection means, which senses a context of a corresponding specific space, and displays the same so that a copy condition, a paste condition, a combination condition, an edit condition, a sharing condition or a detection means can be selected; and
a communication module which provides a communication interface for performing a reliable wireless communication.

34. The copier of claim 31, wherein said inherent identification number of the space copier is formed of either URN or URI of the context ontology.

35. The copier of claim 32, wherein said space copier is adapted to a mobile communication terminal such as a PCS phone, a cellular phone, PDA or something or is adapted to one of a small size portable communication apparatus which has a wireless data communication function and is provided with a program which is able to copy, paste, edit, combine or share the context of a space.
